(19) United States
(12) Patent Application Publication
(10) Pub. No.: US 2025/0206113 A1
(43) Pub. Date: Jun. 26, 2025

(54) SOLAR PICKUP TRUCK BED COVER WITH LOCK BOLT STRUCTURE

(71) Applicant: Yunxia SHAO, HANGZHOU (CN)

(72) Inventors: Shaoyong ZHENG, HANGZHOU (CN); Yunxia SHAO, HANGZHOU (CN)

(21) Appl. No.: 18/969,137

(22) Filed: Dec. 4, 2024

(30) Foreign Application Priority Data
Dec. 22, 2023 (CN) 202323539677.6

(51) Int. Cl. B60J 7/16

(52) U.S. Cl. CPC B60J 7/1621

(57) ABSTRACT

The invention discloses a rotating shaft structure including a rotating shaft, a hinge assembly and an intermediate rubber strip. There are two such rotating shafts, and the rotating shafts comprise a plate connecting frame, a rotating cavity, and a rubber strip insertion portion. The plate connecting frame is used for connecting plates, the rotating cavity is rotationally connected to the hinge assembly, and the rubber strip insertion portion is used for connecting the intermediate rubber strip. The hinge assembly includes a connecting bracket, both ends of which are connected to a hinge rotating head, the hinge rotating head is rotationally connected to the rotating cavity.

### CROSS-REFERENCES TO RELATED APPLICATIONS

The present disclosure claims the priority of Chinese Patent Application No. 202323539677.6, filed on Dec. 22, 2023, the entireties of which are herein incorporated by reference.

### FIELD

The invention is relevant to the automobile accessories field, especially about A rotating shaft structure and a car cover with such a structure.

### BACKGROUND

Pickup trucks are one of the common automobiles in life. Due to the advantages of comfort, stability and ability to transport goods, pickup trucks are an integral part of the automobile market. The rear cargo hopper, as the most significant feature of pickup trucks, is often used for transportation of goods.

Most of the conventional pickup trucks have an open structure, which can't protect the cargo in rainy or snowy days. Therefore, many pickup trucks began to be equipped with a separate cover, when the car cover is in use, the front part usually does not need to be opened, while the rear part needs to be opened frequently, which makes the rotating shaft structure at the rear of the cover more vulnerable to damage; secondly, since the rotating shaft structure needs to be rotated, a certain gap has to be ensured, which makes it prone to water leaking.

### SUMMARY

To overcome the shortcomings of the conventional technology, the invention aims to provide a rotating shaft structure, which improves the service life of the rotating shaft structure by pressurizing the hinge, thereby providing a good waterproofing effect to resolve the above problems.

To solve the conventional technical problem above, thus the invention use the following method:

A rotating shaft structure comprises a rotating rod, a hinge assembly, an intermediate rubber strip and a hinge joint.

There are two rotating rods, the two rotating rods are connected by the hinge assembly, the two rotating rods are each connected with an intermediate rubber strip, the two intermediate rubber strips form an extruded surface to form a waterproof rubber strip, the two ends of the rotating rods are connected with a hinged joint respectively.

By adding a hinge to the conventional rotating shaft structure and utilizing the hinge to drive the two rotating cavities to rotate relative to each other, which enables the smooth rotation of the two rotating shafts, meanwhile, the plate connecting frame is utilized to connect the plate, the intermediate rubber strip is connected to the rubber strip insertion portion.

Further, the rotating rod comprises a plate connecting frame, a rotating cavity and an rubber strip insertion portion; the plate connecting frame is used for connecting plates, the rotating cavity is rotationally connected to the hinge assembly, the rubber strip insertion portion is used for connecting the intermediate rubber strip, the rubber strip insertion portions of the two rotating rods are set opposite to each other, each of the two rubber strip insertion portions is connected with an intermediate rubber strip, the two intermediate rubber strips abutting each other; the hinge assembly comprises a connecting bracket, both end of the connecting bracket are connected with a hinge rotating head, the hinge rotating head is rotationally connected to the rotating cavity.

Further, the rubber strip insertion portions of the two rotating rods are set opposite to each other, each of the two rubber strip insertion portions is connected to an intermediate rubber strip, the two intermediate rubber strips are abutted against each other, the intermediate rubber strips are provided for a waterproof effect, as the intermediate rubber strips have a certain degree of elasticity that can be squeezed, their ability to be squeezed is utilized to make up for the gaps generated between the profiles, and to provide a very good rainproof effect.

Further, both of the two rotating rods is provided with a rotating rod gluing surface, the intermediate rubber strip comprises an insertion portion, a compression chamber and a gluing surface, the insertion portion extends into the rubber strip insertion portion, the gluing surface is bonded with the rotating rod gluing surface, the rubber strip insertion portion is provided to facilitate the connection of the intermediate rubber strip, and is not easy to fall off after connection, but in order to improve the sealing of the intermediate rubber strip and the rotating rod, the intermediate rubber strip is bonded to the rotating rod by gluing at the connection point so as to ensure the sealing thereof, the compression chamber is provided to allow sufficient elasticity of the intermediate rubber strip so that the intermediate rubber strip can be deformed by sufficient extrusion to improve the sealing effect.

Further, the intermediate rubber strip comprises an abutting portion, the abutting portion is used for abutting the rotating rod, one side of the connecting bracket is connected with a support block, the support block is used to support the bottom surface of the rotating rod.

Further, the hinge assembly comprises a positioning piece, the positioning piece is connected to the rotating rod, the positioning piece is used to limit the hinge assembly. By providing the positioning piece, the hinge assembly is limited and prevented from moving.

Further, it comprises a hinge joint, there are four hinge joints, each end of the rotating shaft is connected to a hinge joint, the hinge joints comprise a joint water outlet, a water catching groove, a first gluing surface, a second gluing surface, a third gluing surface, a rubber strip insertion groove, a profile insertion head, a rotating connecting portion, a screw fixing hole, a second screw fixing port and a second profile insertion head, the rotating rod further comprises a joint insertion port, the profile insertion head is mated with the joint insertion port. The screw fixing holes are provided in correspondence with the screw holes of the rotating rod, the hinge joint is to enable the rotating shaft structure at the end to adapt with the side rail structure, the hinge joint is provided to enable the rotating shaft structure to be adapted with the side rail structure at the end, the hinge joint should be able to rotate with the rotating shaft, as well as to realize a good waterproof effect, by providing the profile insertion head to match with the joint insertion port on the rotating rod, and using the straight insertion method to connect to make the installation more convenient.

Further, the rotating shaft comprises a joint insertion port, the profile insertion head is mated with the joint insertion port, the screw fixing holes are provided in correspondence with the screw holes of the rotating shaft; the rotating connecting portion is rotationally connected with a rotating cavity, the intermediate rubber strip extends into the rubber strip insertion groove, the intermediate rubber strip is bonded with the first gluing surface, the second gluing surface and the third gluing surface, the water catching groove is connected with the joint water outlet, the water catching groove is used to guide water flow, the second profile insertion head is inserted into the side rail, by setting the rotating connecting portion, the hinge joint can be synchronously rotated with the rotating rod, by setting the rubber strip insertion groove, the intermediate rubber strip is made to pass through the rotating shaft and the hinge joint, thereby making the rotating shaft and the hinge joint connected as an integral whole, secondly, the intermediate rubber strip and the rubber strip insertion groove are glued together to ensure its sealing and to improve the waterproof effect.

Further, a water catching groove is provided below the rubber strip insertion groove, in order to prevent the two intermediate rubber strips from leaking at the hinge joint, by providing a water catching groove on the lower side of the intermediate rubber strips, so that if there is any water leaking from the intermediate rubber strips will fall into the water catching groove, and then flow out from the joint water outlet along with the water catching groove.

A car cover comprises a guide rail, a rotating shaft structure and a front plate fixing system, the front plate fixing system comprises a front bar fixing structure, a front bar wrench assembly and a front bar plate, the front bar fixing structure and the front bar wrench assembly are connected to the front bar plate, the front bar fixing structure is connected to the front edge, the front bar wrench assembly is connected to the rear edge of the front bar plate.

Further, the front bar wrench assembly comprises a fixing hook and a fixing wrench, the fixing hook is slidingly connected to the guide rail, the fixing wrench is clamped with the fixing hook.

Further, the fixing hook is provided with a front bar fixing wrench hook, the fixing wrench is provided with a front bar fixing wrench upper hook, the front bar fixing wrench hook is clamped with the front bar fixing wrench upper hook.

Further, the front bar wrench assembly comprises a fixing hook and a fixing wrench, the fixing hook is connected to the side rail, the fixing wrench is connected to the front bar, by setting a rotating shaft structure and utilizing the rotating shaft structure to connect the two plates, it makes the opening and closing of the car cover more smooth and has good rain-proof effect, by adopting a front bar fixing structure and a front bar wrench assembly to connect the front bar with the side rail, it can not only ensure the stable connection of the front bar, but also make the front bar easy to be opened.

The beneficial effects of this invention are:

1. The invention by adding a hinge on the conventional rotating shaft structure, utilizing the hinge to drive the two rotating cavities to rotate relative to each other, which enables the smooth rotation of the two rotating shafts, meanwhile, the plate connecting frame is utilized to connect the plates, the intermediate rubber strip is connected to the rubber strip insertion portion.

2. The invention makes the switching of the car cover smoother and has a good rainproof effect by setting a rotating shaft structure and utilizing the rotating shaft structure to connect the two plates.

3. The invention adopts a front bar fixing structure and a front bar wrench assembly to connect the front bar with the side rail, which can not only ensure the stability of the connection of the front bar, but also make the front bar easy to open.

### BRIEF DESCRIPTION OF THE DRAWINGS

FIG. 1 is a structural schematic diagram of the rotating shaft structure in the invention.

FIG. 2 is an exploded view of the rotating shaft structure in the invention.

FIG. 3 is a partial enlarged diagram in FIG. 2.

FIG. 4 is a connection schematic diagram of the joint in the invention.

FIG. 5 is a cross-sectional view I of a rotating shaft structure in the invention.

FIG. 6 is a cross-sectional view II of the rotating shaft structure in the invention.

FIG. 7 shows a cross-sectional view III of a rotating shaft structure in the invention.

FIG. 8 is a structural schematic diagram of embodiment 5.

FIG. 9 is a structural schematic diagram of embodiment 5.

FIG. 10 is a structural schematic diagram I of a joint in the invention.

FIG. 11 is a structural schematic diagram II of the joint in the invention.

FIG. 12 is a structural schematic diagram III of the joint in the invention.

FIG. 13 is a structural schematic diagram I of the car cover.

FIG. 14 is a structural schematic diagram II of the car cover.

FIG. 15 is a partial schematic diagram of the car cover.

FIG. 16 is a partially enlarged view of part B in FIG. 15.

In the figure: 1—Guide rail; 2—Front bar fixing structure; 3—Front bar wrench assembly; 31—Fixing hook; 3101—Front bar fixing wrench hook; 32—Fixing wrench; 3201—Front bar fixing wrench upper hook; 4—Plate; 5—Rotating shaft structure; 51—Hinge joint; 5101—Joint water outlet; 5102—Water catching groove; 5103—First gluing surface; 5104—Second gluing surface; 5105—Third gluing surface; 5106—Rubber strip insertion groove; 5107—Profile insertion head; 5108—rotating connecting portion; 5109—Screw fixing hole; 5110—Second screw fixing port; 5111—Second profile insertion head; 54—Rotating rod; 542—Right rotating shaft; 541—Left rotating shaft; 5401—Rotating shaft gluing surface; 5402—Joint insertion port; 5403—Plate connecting frame; 5404—Rotating cavity; 5405—Rubber strip insertion portion; 55—Intermediate rubber strip; 551—First intermediate rubber strip; 552—Second intermediate rubber strip; 5501—Extruding surface; 5502—Gluing surface; 5503—Insertion portion; 5504—Compression chamber; 5505—Abutting portion; 57—Hinge assembly; 5701—Hinge rotating head; 5702—Connecting bracket; 5703—Support block; 50—Positioning piece.

### DETAILED DESCRIPTION OF THE DISCLOSURE

The following instruction further explains the invention's concrete implementation method.

In order to enable a clearer understanding of the above-mentioned objects, features and advantages of the present invention, the present invention will be described in detail below in connection with the accompanying drawings and specific embodiments. It should be noted that the embodiments of the present application and the features in the embodiments can be combined with each other without conflict.

The terms “first,” “second,” “third,” etc. are only used to differentiate the description and should not be understood as indicating or implying relative importance.

In the description, it should also be noted that, unless otherwise expressly specified and limited, the terms “arranged,” “installed,” “connected,” and “combined” should be understood in a broad sense; for example, it may be a fixing connection, it can also be a detachable connection or an integral connection; it can be a mechanical connection or an electrical connection; it can be a direct connection or an indirect connection through an intermediate media, and it can be internal connection within two components. For those of ordinary skill in this field, the meanings of the above terms in the present invention can be understood in specific situations.

The specific embodiments of the present invention will be described in detail below in connection with the accompanying drawings. It should be understood that the specific embodiments described herein are intended only to illustrate and explain the present invention and are not intended to limit it.

### Embodiment 1

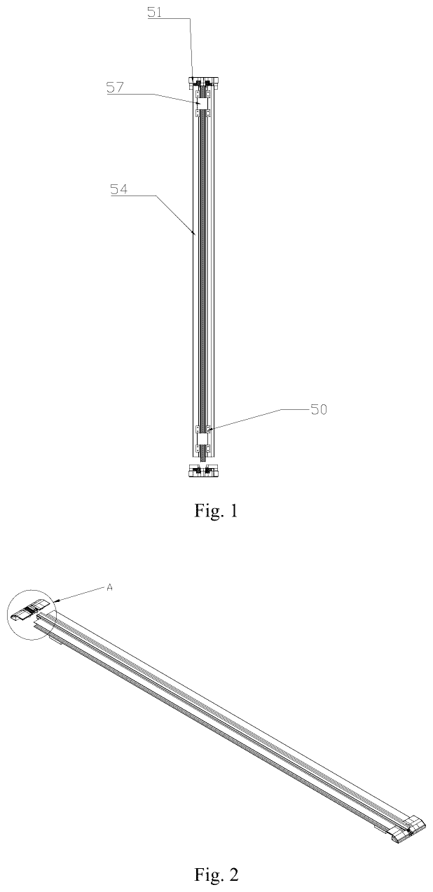

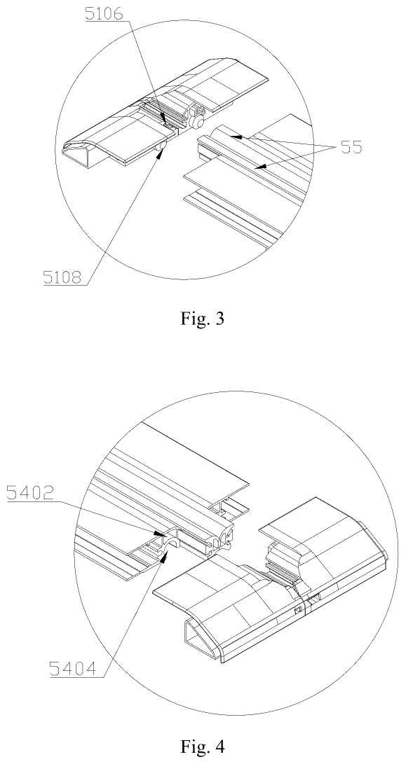

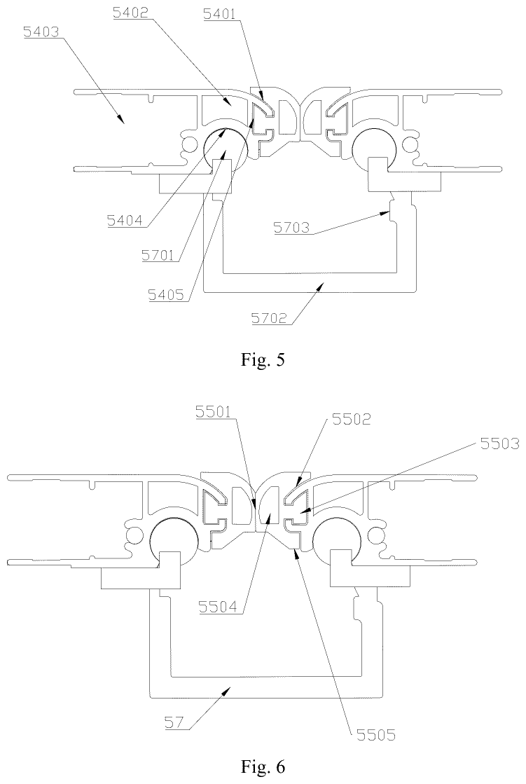

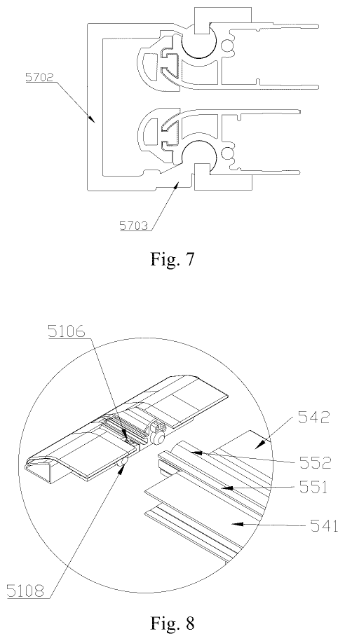

As shown in FIGS. 1-7, a rotating shaft structure comprises a rotating rod 54, a hinge assembly 57, an intermediate rubber strip 55 and a hinge joint.

There are two rotating rods 54, the two rotating rods 54 are connected by the hinge assembly, the two rotating rods are each connected with an intermediate rubber strip, the two intermediate rubber strips form an extruded surface to form a waterproof rubber strip, the two ends of the rotating rods are connected with a hinge joint respectively.

The rotating rods 54 comprise a plate connecting frame 5403, a rotating cavity 5404 and a rubber strip insertion portion 5405.

The plate connecting frame 5403 is used for connecting the plates 4, the rotating cavity 5404 is rotationally connected to the hinge assembly 57, the rubber strip insertion portion 5405 is used for connecting the intermediate rubber strips 55.

The hinge assembly 57 comprises a connecting bracket 5702, each end of the connecting bracket 5702 is connected with a hinge rotating head 5701, the hinge rotating head 5701 is rotationally connected to the rotating cavity 5404.

By adding a hinge on the conventional rotating shaft structure 5 and utilizing the hinge to drive the two rotating cavities 5404 to rotate relative to each other, it is possible to ensure the smooth rotation of the two rotating rods 54, meanwhile, utilizing the plate connecting frame 5403 to connect the plate 4, and by connecting an intermediate rubber strip 55 to the rubber strip insertion portion 5405, when the two rotating rods 54 are parallel (i.e., when the two plates 4 are parallel), the two intermediate rubber strips 55 resist to each other to provide a good waterproof effect.

### Embodiment 2

On the basis of Embodiment 1, the rubber strip insertion portions 5405 of the two rotating rods 54 are provided opposite to each other, each of the two rubber strip insertion portions 5405 is connected with an intermediate rubber strip 55, the two intermediate rubber strips 55 are abutted against each other.

The intermediate rubber strips 55 are provided for a waterproof effect, as the intermediate rubber strips 55 have a certain degree of elasticity that can be squeezed, their ability to be squeezed is utilized to make up for the gaps generated between the profiles, and to provide a good rainproof effect.

Each of the two rotating rods 54 is provided with a rotating rod gluing surface 5401, the intermediate rubber strip 55 comprises an insertion portion 5503, a compression chamber 5504 and a gluing surface 5502, the insertion portion 5503 extends into the rubber strip insertion portion 5405 the gluing surface 5502 is bonded with the rotating rod gluing surface 5401.

The rubber strip insertion portion 5405 is provided to facilitate the connection of the intermediate rubber strip 55 and is not easy to fall off after connection, but in order to improve the sealing of the intermediate rubber strip 55 and the rotating rod, the intermediate rubber strip 55 is bonded to the rotating rod 54 by gluing at the connection point so as to ensure the sealing thereof.

The compression chamber 5504 is provided to allow sufficient elasticity of the intermediate rubber strip 55 so that the intermediate rubber strip 55 can be deformed by sufficient extrusion to improve the sealing effect.

### Embodiment 3

On the basis of embodiment 2, the intermediate rubber strip 55 further comprises an abutting portion 5505, the abutting portion 5505 is used for abutting the rotating rod 54.

The bottom of the intermediate rubber strip 55 is further provided with the abutting portion 5505, so that when the car cover is leveled, the abutting portion 5505 on the lower side of the intermediate rubber strip 55 abuts the rotating rod 54, which enhances the overall strength of the intermediate rubber strip 55, thereby making the two intermediate rubber strips 55 squeeze each other tightly, providing stronger sealing, and improving waterproofing effect.

One side of the connecting frame 5702 is connected with a support block 5703, the support block 5703 is used to support the bottom surface of the rotating rod 54.

When the car cover is opened, one plate 4 will fall on top of another plate 4, which is likely to cause deformation of the hinge assembly 57 due to the overall weight of the plate 4. In order to prolong the service life of the hinge assembly 57, a support block 5703 is placed against the rotating rod 54, utilizing the support block 5703 to transfer a portion of the force to the rotating rod 54.

The hinge assembly 57 further comprises a positioning piece 50, the positioning piece 50 is connected to the rotating rod 54, the positioning piece 50 is used to limit the hinge assembly 57. By providing the positioning piece 50, the hinge hinge assembly 57 is limited and prevented from moving.

### Embodiment 4

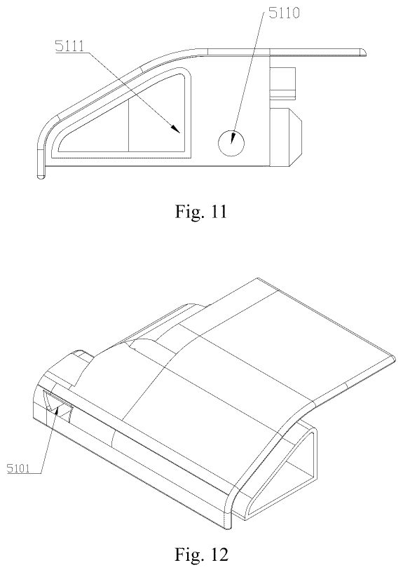

On the basis of embodiment 3, as shown in FIGS. 10-12, it further comprises a hinge joint 51, there are four hinge joints 51, each end of the rotating rod 54 is connected to a hinge joint 51, the hinge joints 51 comprise a joint water outlet 5101, a water catching groove 5102, a first gluing surface 5103, a second gluing surface 5104, a third gluing surface 5105, a rubber strip insertion groove 5106, a profile insertion head 5107, a rotating connecting portion 5108, a screw fixing hole 5109, a second screw fixing port 5110 and a second profile insertion head 5111.

The rotating rod 54 further comprises a joint insertion port 5402, the profile insertion head 5107 is mated with the joint insertion port 5402, the screw fixing holes 5109 are provided in correspondence with the screw holes of the rotating rod 54.

The hinge joint 51 is provided to enable the rotating shaft structure 5 to be adapted with the side rail structure at the end, the hinge joint 51 should be able to rotate with the rotating shaft 54 as well as to realize a good waterproof effect at the same time.

By providing the profile insertion head 5107, to match with the joint insertion port 5402 on the rotating rod 54 and using the straight insertion method to connect, and make the installation more convenient.

The rotating connecting portion 5108 is rotationally connected to the rotating cavity 5404, the intermediate rubber strip 55 extends into the rubber strip insertion groove 5106, the intermediate rubber strip 55 is bonded to with the first gluing surface 5103, the second gluing surface 5104 and the third gluing surface 5105.

The water catching groove 5102 is connected with the joint water outlet 5101, the water catching groove 5102 is used to guide the water flow.

The second profile insertion head 5111 is inserted into the side rail.

By setting the rotating connecting portion 5108, the hinge joint 51 can be synchronously rotated with the rotating rod 54, by setting the rubber strip insertion groove 5106, the intermediate rubber strip 55 can pass through the rotating rod 54 and the hinge joint 51, thereby making the rotating rod 54 and the hinge joint 51 as an integral whole, secondly, the intermediate rubber strip 55 and the rubber strip insertion groove 5106 are glued to ensure its sealing and to improve the waterproof effect.

The water catching groove 5102 is provided below the rubber strip insertion groove 5106, in order to prevent the two intermediate rubber strips 55 from leaking at the hinge joint 51, by providing the water catching groove 5102 on the lower side of the intermediate rubber strips 55, so that if there is any water from the intermediate rubber strips 55, it will all fall into the water catching groove 5102, and then flow out from the joint water outlet 5101 along with the water catching groove 5102.

### Embodiment 5

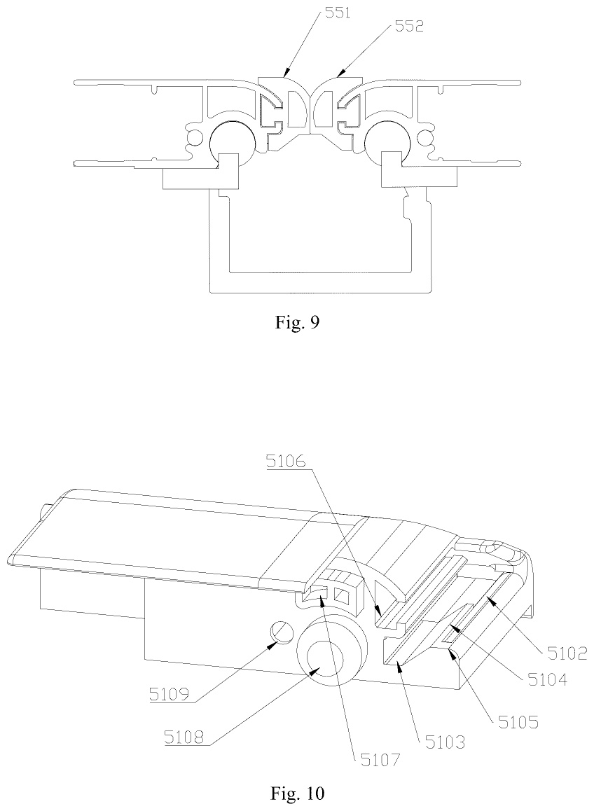

On the basis of embodiment 3, as shown in FIGS. 8 and 9, a rotating shaft structure comprises a left rotating rod 541, a right rotating rod 542, a hinge assembly 57, a first intermediate rubber strip 551, a second intermediate rubber strip 552, a first hinge joint, a second hinge joint, a third hinge joint, and a fourth hinge joint. (Herein, in conjunction with the accompanying FIGS. 8 and 9, it can be seen that the first intermediate rubber strip 551 and the second intermediate rubber strip 552 are of different structures, the left rotating rod 541 and the right rotating rod 542 are of different structures, also the first hinge joint, the second hinge joint, the third hinge joint, and the fourth hinge joint are also not identical to each other.)

The left rotating rod 541 and the right rotating rod 542 are connected by a hinge assembly 57, the first intermediate rubber strip 551 is connected to the left rotating rod 541, the second intermediate rubber strip 552 is connected to the right rotating rod 542, the first intermediate rubber strip 551 and the second intermediate rubber strip 552 are formed into an extruded surface to form a waterproof rubber strip, the two ends of the left rotating rod 541 are connected with the first hinge joint and the second hinge joint respectively, the two ends of the left rotating rod 541 are connected with the first hinge joint and the second hinge joint respectively, the two ends of the right rotating rod 542 are connected with the third hinge joint and the forth hinge joint respectively.

Both of the left rotating bar 541 and the right rotating bar 542 comprise a plate connecting frame 5403, a rotating cavity 5404 and a rubber strip insertion portion 5405;

The plate connecting frame 5403 is used for connecting plates 4, the rotating cavity 5404 is rotationally connected to a hinge assembly 57, the rubber strip insertion portions 5405 of the left rotating rod 541 and right rotating rod 542 are set opposite to each other, the two rubber strip insertion portions 5405 are connected to a first intermediate rubber strip 551 or a second intermediate rubber strip 552 respectively, the first intermediate rubber strip 551 and the second intermediate rubber strips 552 abutting each other;

The hinge assembly 57 comprises a connecting bracket 5702, both ends of the connecting bracket 5702 are connected with a hinge rotating head 5701, the hinge rotating head 5701 is rotationally connected with two rotating cavities 5404.

Both of the left and right rotating rods are provided with a rotating rod gluing surface, both of the first intermediate rubber strips 551 and the second intermediate rubber strips 552 comprise an insertion portion 5503, a compression chamber 5504, and a gluing surface 5502, the insertion portion 5503 extends into the rubber strip insertion portion 5405, the gluing surface 5502 is bonded with the rotating rod gluing surface 5401.

Both of the first intermediate rubber strip 551 and the second intermediate rubber strip 552 are provided with an abutting portion 5505, the abutting portion 5505 is used for abutting the rotating rod 54.

The hinge assembly 57 further comprises a positioning piece 50, the positioning piece 50 is connected to the left rotating bar 541 and the right rotating bar 542, the positioning piece 50 is used to limit the hinge assembly 57.

The first hinge joint comprises a joint water outlet 5101, a water catching groove 5102, a first gluing surface 5103, a second gluing surface 5104, a third gluing surface 5105, a rubber strip insertion groove 5106, a profile insertion head 5107, a rotating connecting portion 5108, a screw fixing hole 5109, a second screw fixing port 5110 and a second profile insertion head 5111;

Both of the left rotating rod 541 and right rotating rod 542 comprise a joint insertion port 5402, the profile insertion head 5107 is mated with the joint insertion port 5402, the screw fixing holes 5109 are provided in correspondence with the screw holes of the left rotating rod or the right rotating rod;

The rotating connecting portion 5108 is rotationally connected to the rotating cavity 5404, the first intermediate rubber strip 551 and the second intermediate rubber strip 552 extend into the rubber strip insertion groove 5106, the first intermediate rubber strip 551 and the second intermediate rubber strip 552 are bonded with the first gluing surface 5103, the second gluing surface 5104, and the third gluing surface 5105;

The water catching groove 5102 is connected to the joint water outlet 5101, the water catching groove 5102 is used to guide the water flow.

Both the second hinge joint, the third hinge joint and the fourth hinge joint comprise a joint water outlet (5101), a water catching groove 5102, a first gluing surface 5103, a second gluing surface 5104, a third gluing surface 5105, an rubber strip insertion groove 5106, a profile insertion head 5107, a rotating connecting portion 5108, a screw fixing hole 5109, a second screw fixing port 5110 and a second profile insertion head 5.

### Embodiment 6

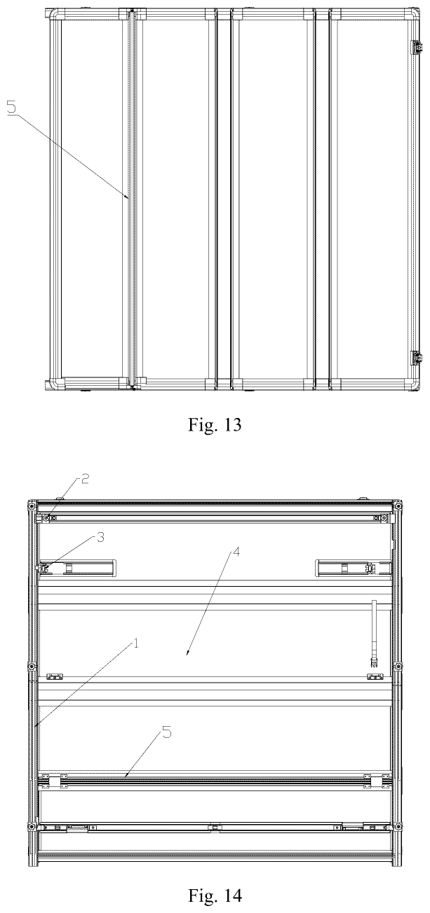

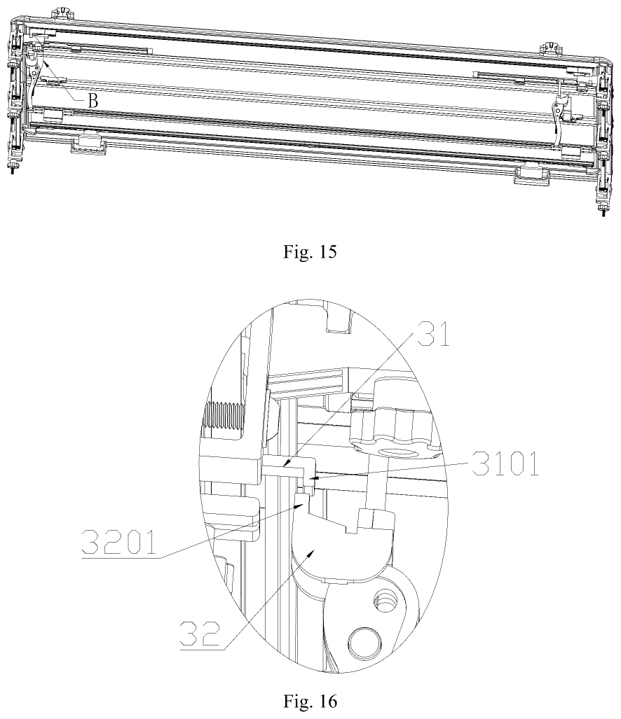

On the basis of embodiment 4 or 5, as shown in FIGS. 13-16, a car cover with a rotating shaft structure comprises a guide rail 1, a front bar, a side rail and a plate 4, the side rail is connected to the car body, the front bar is connected to the side rail by a front bar fixing structure 2 and a front bar wrench assembly 3, one of the plates 4 is rotationally connected to the front bar, and two adjacent plates 4 are connected to each other by a rotating shaft structure 5.

The front bar wrench assembly 3 comprises a fixing hook 31 and a fixing wrench 32, the fixing hook 31 is connected to the side rails, the fixing wrench 32 is connected to the front bar.

By setting up the rotating shaft structure 5 and utilizing the rotating shaft structure 5 to connect the two plates 4, it makes the opening and closing of the car cover smoother and has a good rainproof effect.

By adopting the front bar fixing structure 2 and the front bar wrench assembly 3 to connect the front bar to the side rail, it can not only ensure the stability connection of the front bar, but also make the front bar easy to open.

### Specific Working Principle:

When it is required to open the car cover, rotate the plate 4, the two adjacent plates 4 rotate at the rotating shaft structure 5, the hinge rotating head 5701 and the rotating cavity 5404 rotate relative to each other, the rotating rod 54 drives the plate 4 to rotate, so that one plate 4 falls on the upper side of the other plate 4, realizing the opening of the car cover.

When the car cover needs to be closed, the plate 4 is rotated so that two adjacent plates 4 rotate at the rotating shaft structure 5, the hinge rotating head 5701 and the rotating cavity 5404 rotate relative to each other, the rotating rod 54 drives the plate 4 to rotate, so that the two plates 4 fall in a uniform plane, and at this time the two intermediate rubber strips 55 are on top of each other, so as to provide a waterproof effect to the rotating shaft structure 5.

The present invention is not limited to the above-mentioned optional embodiments, anyone can draw other various forms of products under the inspiration of the present invention. However, no matter what changes are made in its shape or structure, all technical solutions that fall within the scope defined by the claims of the present invention should fall within the protection scope of the present invention.

What is claimed is:

1. A rotating shaft structure comprising a left rotating rod, a right rotating rod, a hinge assembly, a first intermediate rubber strip, a second intermediate rubber strip, a first hinge joint, a second hinge joint, a third hinge joint, and a fourth hinge joint, wherein
the left rotating rod and the right rotating rod are connected by the hinge assembly, the first intermediate rubber strip is connected to the left rotating rod, the second intermediate rubber strip is connected to the right rotating rod, the first intermediate rubber strip and the second intermediate rubber strip are formed into an extruded surface thus forming a waterproof rubber strip, the two ends of the left rotating rod are connected with the first hinge joint and the second hinge joint respectively, and the two ends of the right rotating rod are connected with the third hinge joint and the fourth hinge joint respectively.

2. A rotating shaft structure comprising a rotating rod, a hinge assembly, an intermediate rubber strip, and a hinge joint, wherein
there are two rotating rods, the two rotating rods are connected by the hinge assembly, the two rotating rods are each connected with an intermediate rubber strip, the two intermediate rubber strips form an extruded surface to form a waterproof rubber strip, the two ends of the rotating rods are connected with a hinge joint respectively.

3. The rotating shaft structure according to claim 2, wherein the rotating rod comprises a plate connecting frame, a rotating cavity, and a rubber strip insertion portion;
the plate connecting frame is used for connecting the plates, the rotating cavity is rotationally connected to the hinge assembly, the rubber strip insertion portion is used for connecting the intermediate rubber strip, the rubber strip insertion portions of the two rotating rods are set opposite to each other, each of the two rubber strip insertion portions is connected with an intermediate rubber strip;
the hinge assembly comprises a connecting bracket, both end of the connecting bracket are connected with a hinge rotating head, the hinge rotating head is rotationally connected to the rotating cavity.

4. The rotating shaft structure according to claim 3, wherein each of the two rotating rods is provided with a rotating shaft gluing surface, the intermediate rubber strip comprises an insertion portion, a compression chamber and a gluing surface, the insertion portion extends into the rubber strip insertion portion, the gluing surface is bonded with the rotating rods gluing surface.

5. The rotating shaft structure according to claim 2, wherein the intermediate rubber strip further comprises an abutting portion, the abutting portion is used for abutting the rotating rod.

6. The rotating shaft structure according to claim 3, wherein one side of the connecting bracket is connected with a support block, the support block is used to support a bottom surface of the rotating rod;
the hinge assembly further comprises a positioning piece, the positioning piece is connected to the rotating rod, the positioning piece is used to limit the position of the hinge assembly.

7. The rotating shaft structure according to claim 6, wherein there are four hinge joints, each end of the rotating rod is connected to a hinge joint, the hinge joints comprise a joint water outlet, a water catching groove, a first gluing surface, a second gluing surface, a third gluing surface, an rubber strip insertion groove), a profile insertion head, a rotating connecting portion, a screw fixing hole, a second screw fixing port and a second profile insertion head;
the rotating rod further comprises a joint insertion port, the profile insertion head is mated with the joint insertion port, the screw fixing holes are provided in correspondence with the screw holes of the rotating shaft;
the rotating connecting portion is rotationally connected with a rotating cavity, the intermediate rubber strip extends into the rubber strip insertion groove, the intermediate rubber strip is bonded with the first gluing surface, the second gluing surface and the third gluing surface; and
the water catching groove is connected with the joint water outlet, the water catching groove is used to guide water flow.

8. A car cover comprising:
a rotating shaft structure comprising a left rotating rod, a right rotating rod, a hinge assembly, a first intermediate rubber strip, a second intermediate rubber strip, a first hinge joint, a second hinge joint, a third hinge joint, and a fourth hinge joint, wherein
the left rotating rod and the right rotating rod are connected by the hinge assembly, the first intermediate rubber strip is connected to the left rotating rod, the second intermediate rubber strip is connected to the right rotating rod, the first intermediate rubber strip and the second intermediate rubber strip are formed into an extruded surface thus forming a waterproof rubber strip, the two ends of the left rotating rod are connected with the first hinge joint and the second hinge joint respectively, and the two ends of the right rotating rod are connected with the third hinge joint and the fourth hinge joint respectively;
a guide rail;
a rotating shaft structure; and
a front plate fixing system, wherein the front plate fixing system comprises a front bar fixing structure, a front bar wrench assembly and a front bar plate, the front bar fixing structure and the front bar wrench assembly are connected to the front bar plate, the front bar fixing structure is connected to a front edge of the front bar, the front bar wrench assembly is connected to a rear edge of the front bar.

9. The car cover according to claim 8, wherein the front bar wrench assembly comprises a fixing hook and a fixing wrench, the fixing hook is slidingly connected to the guide rail, the fixing wrench is clamped with the fixing hook.

10. The car cover according to claim 9, wherein the fixing hook is provided with a front bar fixing wrench hook, the fixing wrench is provided with a front bar fixing wrench upper hook, the front bar fixing wrench hook is clamped with the front bar fixing wrench upper hook.
